(19) United States
(12) Patent Application Publication
(10) Pub. No.: US 2016/0346796 A1
(43) Pub. Date: Dec. 1, 2016

(54) Warming Fluid Dispenser

(71) Applicants: Robin Roberts, West Orange, NJ (US); Nathan Pahucki, Miami, FL (US)

(72) Inventors: Robin Roberts, West Orange, NJ (US); Nathan Pahucki, Miami, FL (US)

(21) Appl. No.: 15/167,544

(22) Filed: May 27, 2016

Related U.S. Application Data
(60) Provisional application No. 62/167,935, filed on May 29, 2015.

(51) Int. Cl. B05B 11/00; H05B 3/42; H05B 1/02

(52) U.S. Cl. CPC B05B 11/0002; B05B 11/3042; H05B 1/0297; H05B 3/42

(57) ABSTRACT

The application provides for a warming fluid dispenser. This dispenser is equipped with two fluid reservoirs, a first reservoir to hold bulk fluids, and a secondary reservoir near the exit nozzle. This secondary reservoir is heated, eliminating issues with “cold starts” that arise in the prior art.

### CROSS REFERENCE TO RELATED APPLICATIONS

This application is a nonprovisional application and as such, claims priority to nonprovisional application Ser. No. 62/167,935 filed on 29 May 2015.

### BACKGROUND OF THE INVENTION

The invention and its embodiments relate to a warming fluid dispenser, in particular an improved warming dispenser for personal lubricants.

Lubricants are pervasive throughout our society. There are many different categories of lubricants. Oil-based, water-based, and silicone-based lubricants are common, and many other categories of lubricants exist, such as biolubricants. Further, even within these categories different lubricants exist for a multitude of different applications. For example, lubricants exist to keep moving parts separated, generally reduce friction, assist in transferring heat, carrying away various debris and contaminants, helping with transmitting power, protecting various articles against wear, preventing corrosion on metals, and acting as a seal for gasses. However, despite all of these uses for different lubricants, one particular use for lubricants is particularly well known in America; the use of personal lubricants.

Even amongst this seemingly-narrow category of lubricants, there exist a multitude of options. Personal lubricants can be water-based, oil-based, or silicone-based, and are frequently optimized during intercourse. Adding to the already vast/large/wide variety, there also exist self-warming lubes, tingling lubricants, flavored lubricants, numbing lubricants and much more.

While self-warming lubricants are popular, the warmth they provide is often transient, and these lubricants can be considerably more expensive than standard personal lubricants. In an attempt to find a solution to this problem, a number of apparatuses have been developed to house lubricant and warm it when desired. However, all of these apparatuses suffer from the flaw that the first volume of lubricant to be dispensed from these apparatuses is not warmed, commonly referred to as a “cold start.” For a product that is often used in the heat of the moment, the first volume of lubricant to be dispensed is frequently the only portion that is used. In those cases, much of the purpose of the prior art is lost. Accordingly, there is a need for an apparatus that is capable of dispensing pre-warmed personal lubricant reliably.

Review of Related Technology:

U.S. Pat. No. 8,365,738 pertains to articles of manufacture including a disposable condom and personal container comprising a condom compartment enclosing one or more condoms immersed in either a personal lubricant or sexually stimulating lubricant removably adjoined to at least one lubricant compartment. The compartments are constructed of a packaging material comprising properties that conduct heat and hermetically sealed. The condom compartment comprises a seal positioned on the top wall that is removed or opened for the purpose of gaining access to the contents. The personal lubricant compartment comprises a discharge element through which the contents of the compartment are discharged by activating a removable dispenser that fits within the element. The contents of the compartments may be heated by a device in which the compartments are seated. The temperature of the contents may be monitored with the aid of a temperature sensing aid.

U.S. Patent Publication No.: 2013/0075384 pertains to a lubricant warming apparatus may warm a container of lubricant to a desired temperature. The apparatus may include an outer shell, a heating shell, and a receptacle. The heating shell maybe nested within the outer shell. The receptacle may be nested within the heating shell. The heating shell may include a lip with tapering contour sides that slope downward from a collar to a front end of the heating shell. The tapering contour sides may expose a front face of the receptacle. A basket may be suspended into the receptacle holding the container of lubricant in a water bath.

U.S. Pat. No. 6,216,911 pertains to a method and apparatus for quickly heating a predetermined volume of viscous fluid and dispensing it efficiently at one or more selected temperatures. The viscous fluid includes non-volatile constituent parts. In one embodiment, the predetermined volume of viscous fluid is partially housed in a pre-delivery chamber separate from the main fluid reservoir. A heater assembly heats the viscous fluid in the pre-delivery chamber in a short time period and in small volumes to prevent overheating and adversely affecting the composition of the viscous fluid. To avoid continually heating the viscous liquid, a timer circuit is used in one embodiment.

Various devices are known in the art. However, their structure and means of operation are substantially different from the present invention. Such devices fail to provide a device that uses a NiCr heating element, is capable of avoiding the common “cold start” problem, and is equipped with a secondary heating reservoir. At least one embodiment of this invention is presented in the drawings below, and will be described in more detail herein.

### BRIEF SUMMARY OF THE INVENTION

The present invention provides for a warming fluid dispenser, comprising: a primary reservoir, capable of holding a first volume of a lubricant; a pump; a feed tube, in fluid communication with said primary reservoir and said pump; an electric motor, capable of operating said pump; a power source, connected to an electronic control unit and said motor, wherein said electronic control unit comprises: a main control chip, a variable resistor, an electronic temperature sensor, a plurality of fixed resistors, at least one LED light; a NiCr heating element, connected to said electronic control unit, wherein said heating element is wrapped around an exit tube; an insulator, that envelops said heating element and said exit tube; a motion detector connected to said electronic control unit; a continuously heated secondary reservoir, capable of holding a second volume of a lubricant, wherein said secondary reservoir is connected to said exit tube and to an exit nozzle, wherein said exit nozzle is capable of dispensing said volume of said lubricant; and a manual control capable of adjusting the flow of said volume of said fluid out of said exit nozzle; wherein said dispenser operates at no greater than 6 watts. Note that no specific voltage/current combination is required for the present invention to operate at this wattage.

In a preferred embodiment, the present invention will dispense personal lubricant, although it should be noted that the present invention is suitable for warming and dispensing any fluid of appropriate viscosity. In another embodiment, the present invention heats the contained lubricant to approximately 98.6° F.

It is an object of the present invention to provide a means for increasing a user's satisfaction.

It is an object of the present invention to provide a means to maintain lubricants at a consistent heated.

It is an object of the present invention to provide a way to avoid “cold starts” when dispensing warmed lubricant.

It is an object of the present invention to provide for the hands-free dispensing of lubricants.

It is an object of the present invention to simplify the process of acquiring heated lubricant.

It is an object of the present invention to provide a medical device that is inexpensive and easy to use.

### BRIEF DESCRIPTION OF DRAWINGS

FIG. 1 is a perspective view of an embodiment of the present invention.

FIG. 2 is a top view of the internals of an embodiment of the nozzle section of the present invention.

FIG. 3 is a bottom view of an embodiment of the nozzle section of the present invention, highlighting the lubricant dispensing mechanism of the present invention.

FIG. 4 is a bottom view of the internals of an embodiment of the present invention, shows one mechanism of pumping lubricant throughout the present invention.

FIG. 5 is a perspective view of an embodiment of the heating element of the present invention.

FIG. 6 is a perspective view of an embodiment of the present invention, showing the secondary reservoir of the present invention.

### DETAILED DESCRIPTION OF THE INVENTION

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

While this disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

As a threshold matter, it should be noted that the present disclosure often makes reference to the warming and dispensing of lubricants. While this device is optimized to function with various personal lubricants, the present invention will operate in a substantially similar manner when used with other fluids, provided that those fluids are of a low enough viscosity that the equipped pump will be able to manipulate it.

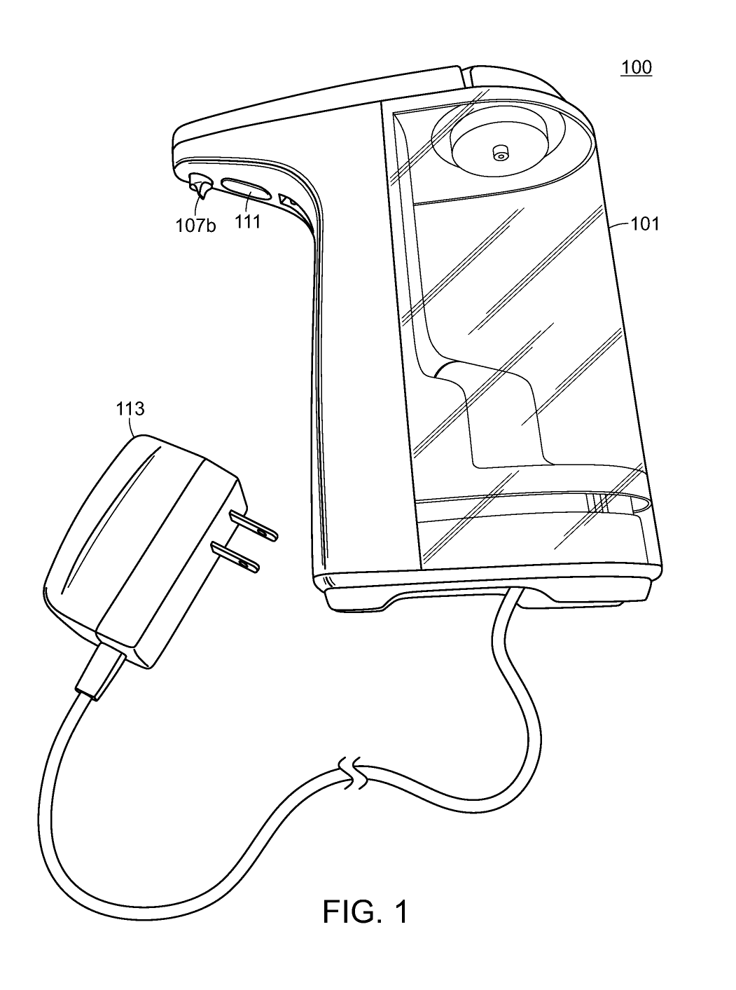

Referring to FIG. 1 a perspective view of an embodiment of the present invention is provided for. This view shows warming fluid dispenser 100. Also shown in this figure are primary reservoir 101, bottom of exit nozzle 107b, motion sensor 111, and power source 113. Primary reservoir 101 serves as the main reservoir of the present invention. In this embodiment of the present invention, bulk amounts of fluid are placed in the primary reservoir waiting to be utilized by the present invention. In one embodiment, primary reservoir 101 is equipped with a separate heating element to warm the fluid before being pumped through warming fluid dispenser 100. In an alternative embodiment, primary reservoir 101 is not equipped with an additional heating element. In one embodiment, motion sensor 111 is used to control the dispensing of the fluid by the present invention. For example, a user may wave a hand or other appendage under the motion sensor in order to dispense fluid into the hand or other appendage.

While FIG. 1 shows power source 113 in the form of a wall plug, in an alternative embodiment, the present invention is powered via an electrochemical battery source or solar power.

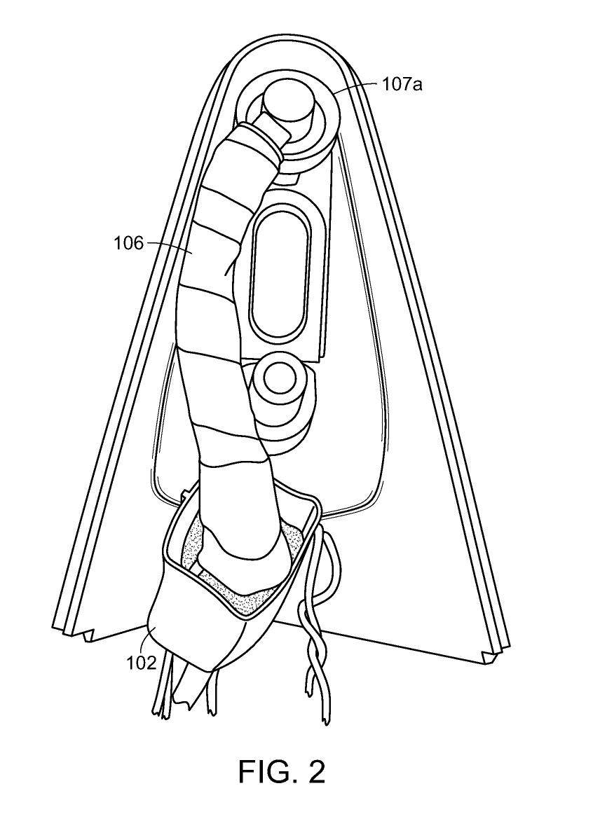

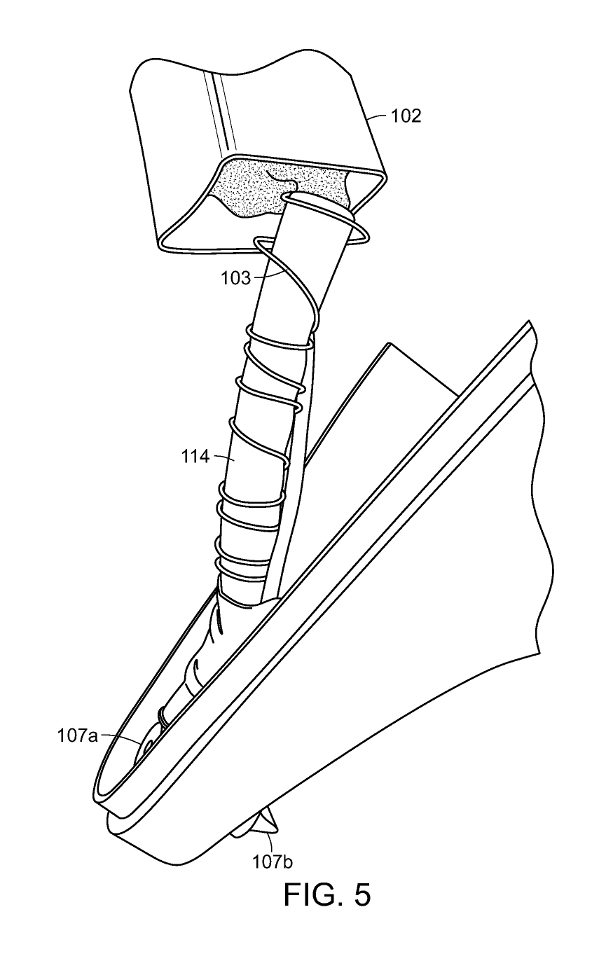

Turning to FIG. 2, a top view of the internals of an embodiment of the nozzle section of the present invention is provided. Here, one can see top of exit nozzle 107a, insulator 106, and secondary reservoir 102. Insulator 106 envelops or encompasses both heating element 103 and exit tube 114 (See FIG. 5). Insulator 106 may be a thermal insulator, an electrical insulator, or some combination thereof. By way of non-limiting example, insulator 106 could be constructed out of glass, porcelain, composite polymers, fiberglass, mineral wool, cellulose, polyurethane foam, polystyrene, A.B.S. (acrylonitrile, butadiene, and styrene), acetate, acrylic, beryllium oxide, ceramic, delrin, kapton, kynar, polycarbonates, melamine, mica, neopreme, nomex, P.E.T., P.E.T.G., polyolefins, PVC, silicone rubber, Teflon, thermoplastics, or any other suitable material.

In a preferred embodiment, secondary reservoir 102 is located in close proximity to the exit nozzle. This proximity provides an important functionality because the fluid located near the exit nozzle will be heated such that it will remain warm upon being distributed, regardless of whether or not the present invention had been recently utilized or not.

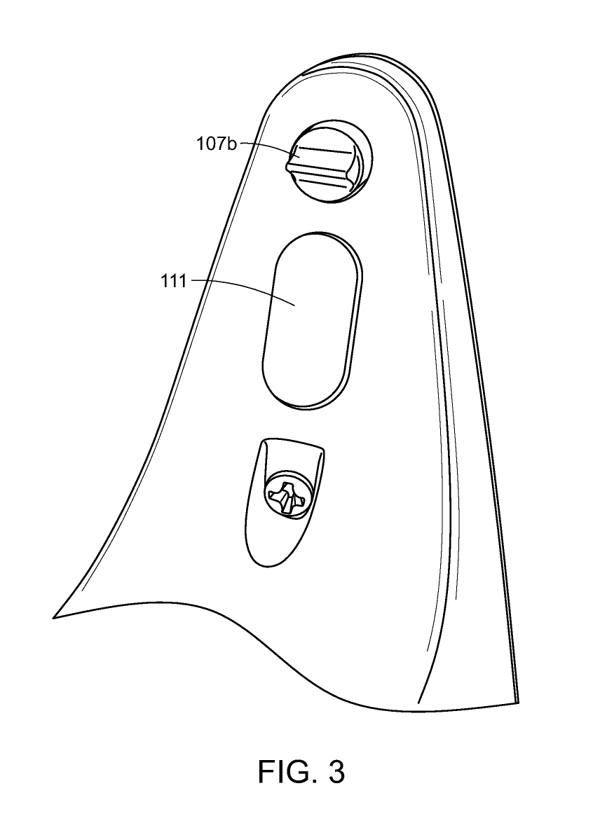

FIG. 3 shows an underside view of an embodiment of the nozzle section of the present invention, highlighting the lubricant dispensing mechanism of the present invention. Of note here are bottom of exit nozzle 107b and motion sensor 111.

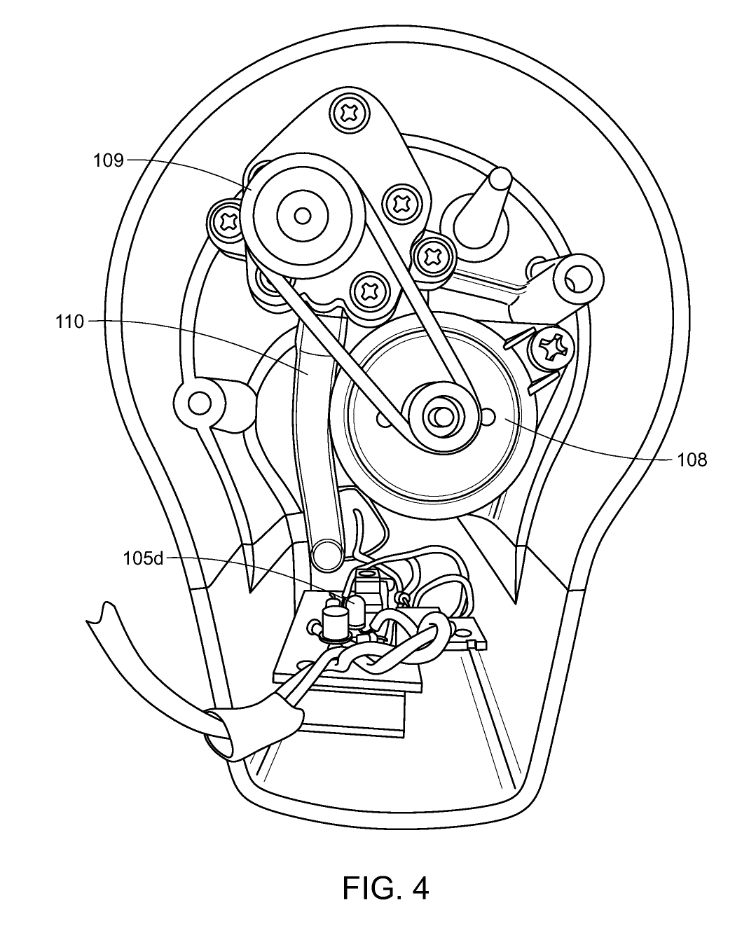

Referring to FIG. 4, a bottom view of the internals of an embodiment of the present invention, shows one mechanism of pumping lubricant throughout the present invention is shown. Here, motor 108, pump 109, feed tube 110, and LED status light 105d are highlighted. In one embodiment, motor 108 is electric. In a preferred embodiment, pump 109 is driven by motor 108. Here, motor 108 powers a belt which in turn causes pump 109 to operate. When pump 109 is in operation, fluid is drawn from primary reservoir 101 (See FIG. 1), into pump 109.

It should be noted that many other motor/pump combinations are suitable for the intended purpose here. In another embodiment, LED status light 105d will turn green when the present invention reaches a preset temperature.

Referring to FIG. 5, is a perspective view of an embodiment of the heating element of the present invention is provided for. It should be noted that in a preferred embodiment, exit tube 114 and heating element 103 are enveloped or encompassed by insulator 106, however, for the purposes of this figure, insulator 106 has been omitted for clarity. This figure shows bottom of exit nozzle 107b and top of exit nozzle 107a, exit tube 114, heating element 103, and secondary reservoir 102. In a preferred embodiment, once in pump 109 (See FIG. 4), the fluid is then pumped into secondary reservoir 102 through feed tube 110 (See FIG. 4). While the fluid is in exit tube 114, heating element 103 warms the fluid to a predetermined temperature and pump 109 fills secondary reservoir with the fluid once fluid has been pumped into secondary reservoir 102, it will continue to be pumped through exit nozzle 114 until the fluid communicated with top of exit nozzle 107a. Upon a user activating the present invention, top of exit nozzle 107a will activate, allowing pump 109 to push warmed fluid out of bottom of exit nozzle 107b and out of the device. The placement of heating element 103 around exit tube 114 prevent the fluid from cooling down, allowing it to be immediately dispensed at a desired temperature instead of forcing the user to wait for the device to heat up.

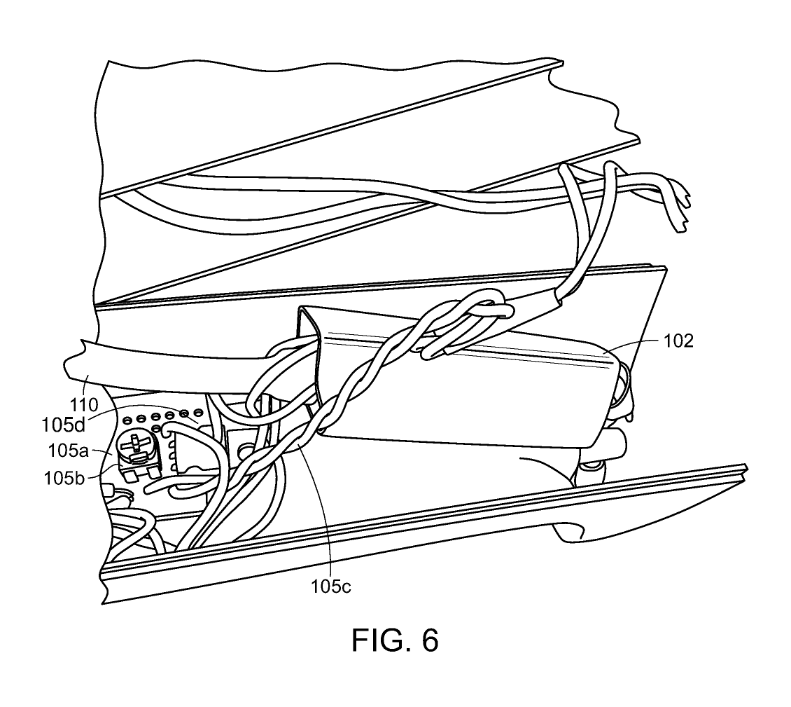

FIG. 6 is a perspective view of an embodiment of the present invention, showing the secondary reservoir of the present invention. This view highlights main control chip 105d, variable resistor 105b, wires 105c, a plurality of transistors 105a, and secondary reservoir 102. Main control chip 105d, variable resistor 105b, plurality of transistors 105a, and electronic temperature sensor (not pictured) are used together to precisely maintain the fluid and a specific temperature. Plurality of transistors 105a are incorporated into the electronics of the present invention, which aid in the operation of the heating element of the present invention.

While the present invention is capable of heating a fluid to an optimized 98.6° F., because the present invention employs an electronic temperature sensor and a variable resistor, many embodiments of the present invention are capable of being set to a custom temperature. In one embodiment, the present invention will be capable of heating the fluid

In an alternative embodiment, the heating elements of the present invention is constructed out of kanthal or any other suitable material.

In a preferred embodiment, the present invention will be capable of warming the fluid anywhere within the range of 90°-105° F. In another embodiment, a user will be able to customize the exact point within this range that they would like their fluid to be heated to.

1. In yet another preferred embodiment, the present invention is equipped with a manual control capable of adjusting the flow of said volume of said fluid out of said exit nozzle.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

What is claimed is:

2. A warming fluid dispenser, comprising:
a primary reservoir, capable of holding a first volume of a fluid;
a pump;
a feed tube, in fluid communication with said primary reservoir and said pump;
a motor, capable of operating said pump;
a power source, coupled to an electronic control unit and said motor;
a heating element, coupled to said electronic control unit,
wherein said heating element is wrapped around an exit tube; and
a secondary reservoir, capable of holding a second volume of a fluid,
wherein said secondary reservoir is connected to said exit tube and to an exit nozzle,
wherein said exit nozzle is capable of dispensing said second volume of said fluid.

3. The warming fluid dispenser of claim 1, wherein said heating element is comprised of NiCr.

4. The warming fluid dispenser of claim 1, wherein said motor is an electric motor.

5. The warming fluid dispenser of claim 1, wherein said lubricant warmer operates at no greater than 6 watts.

6. The warming fluid dispenser of claim 1, wherein said heating element and said exit tube are enclosed by an insulator.

7. The warming fluid dispenser of claim 1, wherein said insulator is selected from the group consisting of: glass, porcelain, composite polymers, fiberglass, mineral wool, cellulose, polyurethane foam, polystyrene, A.B.S., acetate, acrylic, beryllium oxide, ceramic, delrin, kapton, kynar, polycarbonates, melamine, mica, neopreme, nomex, P.E.T., P.E.T.G., polyolefins, PVC, silicone rubber, Teflon®, and thermoplastics.

8. The warming fluid dispenser of claim 1, wherein said fluid is a lubricant.

9. The warming fluid dispenser of claim 7, wherein said lubricant is a personal lubricant.

10. The warming fluid dispenser of claim 1, wherein said electronic control unit comprises:
a main control chip;
a variable resistor;
a temperature sensor;
a plurality of fixed resistors;
a plurality of transistors;
at least one LED light.

11. The warming fluid dispenser of claim 9, wherein said temperature sensor is electronic.

12. The warming fluid dispenser of claim 1, further comprising:
a motion detector, connected to said electronic control unit.

13. The warming fluid dispenser of claim 1, further comprising:
a manual control capable of adjusting the flow of said volume of said fluid out of said exit nozzle.

14. The warming fluid dispenser of claim 1, wherein said dispenser heats said volume of said liquid to approximately 98.6° F.

15. The warming fluid dispenser of claim 1, wherein said secondary reservoir is continuously heated.

16. The warming fluid dispenser of claim 1, wherein said second volume of said fluid and is smaller than said first volume of said fluid.

17. A warming lubricant dispenser, comprising:
a primary reservoir, capable of holding a first volume of a lubricant;
a pump;
a feed tube, in fluid communication with said primary reservoir and said pump;
an electric motor, capable of operating said pump;
a power source, connected to an electronic control unit and said motor,
wherein said electronic control unit comprises:
a main control chip,
a variable resistor,
an electronic temperature sensor,
a plurality of transistors,
a plurality of fixed resistors,
at least one LED light;
a NiCr heating element, connected to said electronic control unit,
wherein said heating element is wrapped around an exit tube;
an insulator, that envelops said heating element and said exit tube;
a motion detector connected to said electronic control unit;
a continuously heated secondary reservoir, capable of holding a second volume of a lubricant,
wherein said secondary reservoir is connected to said exit tube and to an exit nozzle,
wherein said exit nozzle is capable of dispensing said first volume of said lubricant and/or said second volume of said lubricant; and
a manual control capable of adjusting the flow of said volume of said fluid out of said exit nozzle;
wherein said dispenser operates at no greater than 6 watts.

18. The warming fluid dispenser of claim 16, wherein said lubricant is a personal lubricant.

19. The warming fluid dispenser of claim 1, wherein said dispenser heats said volume of said liquid within the range of 90°-105° F.

20. The warming fluid dispenser of claim 1, wherein said second volume of said fluid and is smaller than said first volume of said fluid.
